(19) United States
(12) Patent Application Publication
(10) Pub. No.: US 2017/0178048 A1
(43) Pub. Date: Jun. 22, 2017

(54) IDENTIFICATION AND PRESENTATION OF TASKS BASED ON PREDICTED PERIODS OF USER AVAILABILITY

(71) Applicant: Microsoft Technology Licensing, LLC, Redmond, WA (US)

(72) Inventors: Nikrouz Ghotbi, Redmond, WA (US); Max G. Morris, Seattle, WA (US)

(21) Appl. No.: 14/978,884

(22) Filed: Dec. 22, 2015

(51) Int. Cl. G06Q 10/06; G06N 7/00

(52) U.S. Cl. CPC G06Q 10/063114; G06N 7/005

(57) ABSTRACT

Systems, methods and computer program products are described herein that automatically identify a task to be performed by a user, obtain an estimate of an amount of time required to complete the task, identify a period of user availability, determine that the period of user availability is suitable for performing at least a portion of the task, and in response to such a determination, cause a reminder or notification about the task to be presented to the user. The determination that the period of user availability is suitable for performing at least a portion of the task may be based at least in part on the estimate of the amount of time required to complete the task. A task completion time model may be automatically generated for the user and utilized to obtain the estimate of the amount of time required to complete the task.

BACKGROUND

A variety of applications (also referred to as end-user computer programs) exist that assist a user in keeping track of tasks that the user wants or needs to perform. These applications typically require the user to identify each task to be performed, and to input each task into a digital calendar, note, to-do list, or other task-tracking interface. Some conventional applications also enable the user to set up automated reminders about tasks. However, these applications typically require the user to input the time(s) when such reminders should be presented. Thus, the foregoing applications require the user to expend a significant amount of effort in driving each of the task identification, task tracking, and task reminder processes.

Furthermore, because the user is relied upon to drive each of these processes, problems can arise if the user fails to identify a task and/or fails to input a task into a task-tracking application. This can result in the user failing to perform various tasks, including important tasks, and also being less productive in general. Additionally, when setting up a reminder, the user may not have sufficient foresight concerning her own future schedule and/or when she might become available to work on a task so as to determine when it would be most useful to be reminded about completing a particular task.

### SUMMARY

Systems, methods and computer program products are described herein that automatically identify a task to be performed by a user, obtain an estimate of an amount of time required to complete the task, identify a period of user availability, determine that the period of user availability is suitable for performing at least a portion of the task, and in response to such a determination, cause a reminder or notification about the task to be presented to the user. The determination that the period of user availability is suitable for performing at least a portion of the task may be based at least in part on the estimate of the amount of time required to complete the task.

In accordance with further embodiments, the systems, methods and computer program products may operate to generate a task completion time model for the user. After a new task is identified that is to be performed by the user, such embodiments may apply the task completion time model to the new task to generate an estimated time to complete the new task. Based at least on the estimated time to complete the new task, the embodiments may identify a suitable period of user availability in which to perform at least a portion of the new task. In response to identifying the suitable period of user availability, the embodiments may cause a reminder or notice about the new task to be presented to the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the claimed subject matter is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the application and, together with the description, further serve to explain the principles of the embodiment and to enable a person skilled in the relevant art(s) to make and use the embodiments.

FIG. 1 is a block diagram of an example system in accordance with an embodiment that automatically identifies and presents tasks to a user based on predicted periods of user availability.

FIG. 2 is a block diagram of a system that generates a user-specific task completion time model in accordance with an embodiment.

FIG. 3 is a flowchart of a method for automatically identifying and presenting tasks to a user based on predicted periods of user availability in accordance with an embodiment.

FIG. 4 is a flowchart of a further method for automatically identifying and presenting tasks to a user based on predicted periods of user availability in accordance with an embodiment.

FIG. 5 is a flowchart of a method for updating a user-specific task completion time model for a user in accordance with an embodiment.

FIG. 6 is a flowchart of a method for generating a user-specific task completion time model for a user in accordance with an embodiment.

FIG. 7 is a flowchart of a further method for generating a user-specific task completion time model for a user in accordance with an embodiment.

FIG. 8 is a block diagram of an example system in accordance with an alternate embodiment that automatically identifies and presents tasks to a user based on predicted periods of user availability.

FIG. 9 is a block diagram of a user device in accordance with an alternate embodiment that automatically identifies and presents tasks to a user based on predicted periods of user availability.

FIG. 10 is a block diagram of an example mobile device that may be used to implement various embodiments.

FIG. 11 is a block diagram of an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

As noted in the Background Section above, a number of applications exist that assist a user in keeping track of tasks that the user wants or needs to perform. These applications typically require the user to identify each task to be performed, and to input each task into a digital calendar, note, to-do list, or other task-tracking interface. Some conventional applications also enable the user to set up automated reminders about tasks. However, these applications typically require the user to input the time(s) when such reminders should be presented. Thus, the foregoing applications require the user to expend a significant amount of effort in driving each of the task identification, task tracking, and task reminder processes.

Furthermore, because the user is relied upon to drive each of these processes, problems can arise if the user fails to identify a task and/or fails to input a task into a task-tracking application. This can result in the user failing to perform various tasks, including important tasks, and also being less productive in general. Additionally, when setting up a reminder, the user may not have sufficient foresight concerning her own future schedule and/or when she might become available to work on a task so as to determine when it would be most useful to be reminded about completing a particular task.

Embodiments described herein address these and other issues by automatically identifying and presenting tasks to a user based on predicted periods of user availability. For example, in accordance with various non-limiting embodiments described herein, a system automatically identifies a task to be performed by a user. The system then automatically determines when the user has some free time and helps the user be more productive by suggesting a task that can be completed in that period of free time. At least a portion of the system may be implemented as an application executing on a user device (e.g., a digital personal assistant, a productivity application, or the like).

There are many instances where a user will have some free time, such as on a bus ride home after school, in between classes, at night before bed, and many others. Some people use this time to address things they remember they want to do or need to do, while others don't and at the end of the day feel like they wasted time. In accordance with embodiments described herein, a system automatically learns when a user has downtime (free time or a period of availability) and identifies a task that the user can address during that downtime, whether it be reading an article that the user saw the other day, calling the user's mother whom the user hasn't called in a while, or getting started on the user's history report.

A description of various example embodiments that automatically identify and present tasks to a user based on predicted periods of user availability is provided in Section II below. Section III describes an example mobile device that may be used implement various embodiments. Section IV describes an example processor-based computer system that may be used to implement various embodiments. Section V describes some additional exemplary embodiments. Section VI provides some concluding remarks.

II. Example Embodiments that Automatically Identify and Presents Tasks to a User Based on Predicted Periods of User Availability

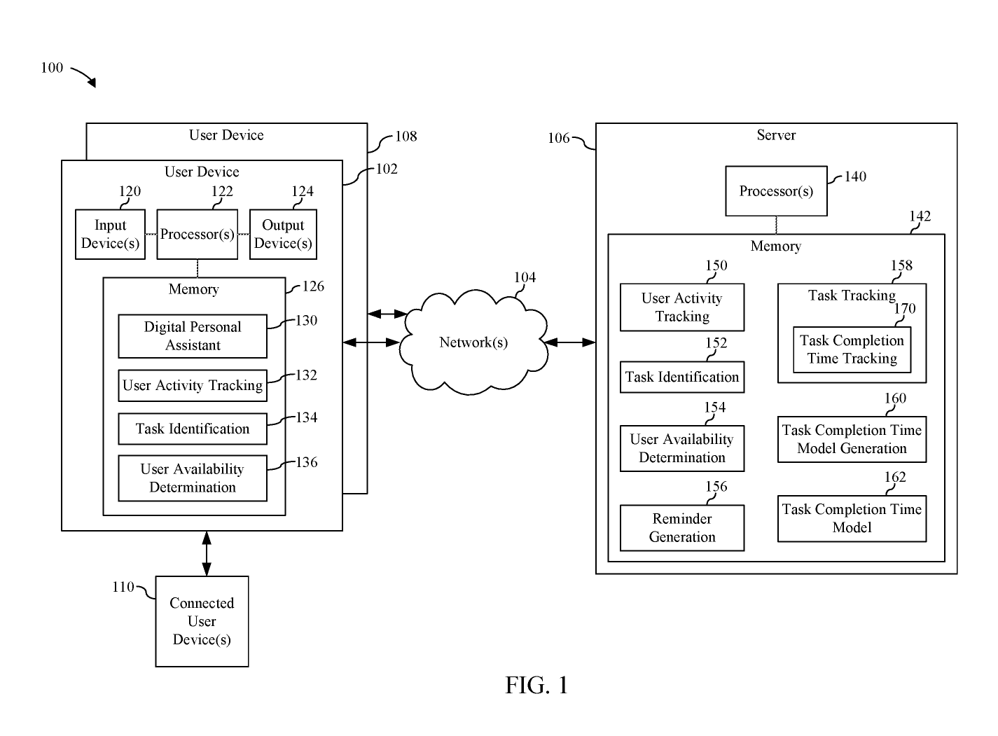

FIG. 1 is a block diagram of an example system 100 that automatically identifies and presents tasks to a user based on predicted periods of user availability. As shown in FIG. 1, system 100 includes a user device 102 that is communicatively connected to a server 106 via one or more networks 104. Each of these components will now be described.

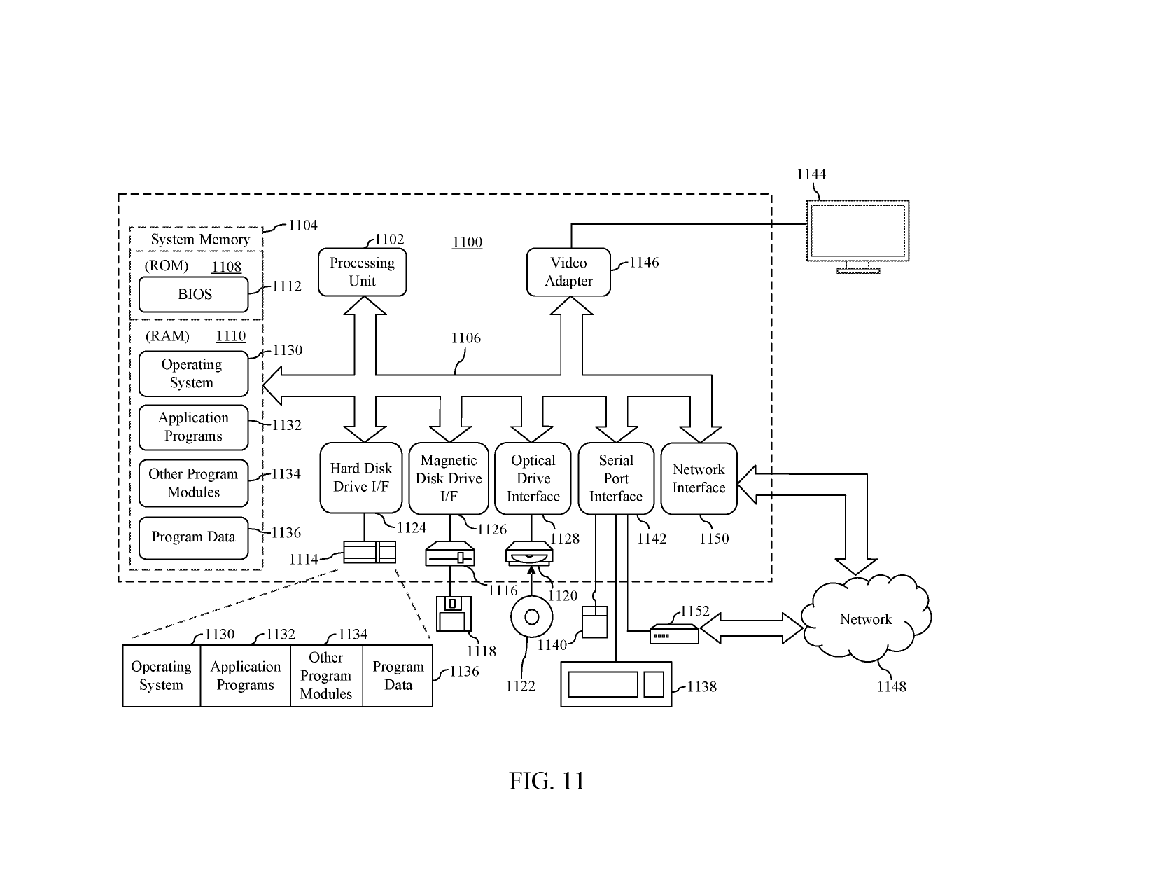

User device 102 is intended to represent a processor-based electronic device that is capable of executing computer programs installed thereon on behalf of a user. In one embodiment, user device 102 comprises a mobile device such as a mobile phone (e.g., a smart phone), a laptop computer, a tablet computer, a netbook, a wearable computer such as a smart watch or a head-mounted computer, a portable media player, a handheld gaming console, a personal navigation assistant, a camera, or any other mobile device capable of executing computer programs on behalf of a user. One example of a mobile device that may incorporate the functionality of user device 102 will be discussed below in reference to FIG. 10. In another embodiment, user device 102 comprises a desktop computer, a gaming console, a smart television (TV) or other non-mobile computing platform that is capable of executing computer programs on behalf of a user. An example desktop computer that may incorporate the functionality of user device 102 will be discussed below in reference to FIG. 11.

User device 102 is capable of communicating with server 106 via one or more networks 104. Server 106 comprises a computer that is programmed to provide task identification, task tracking, and task reminder services in support of one or more computer programs executing on user device 102. Such services will be described below.

Network(s) 104 is intended to represent any type of network or combination of networks suitable for facilitating communication between user devices, such as user device 102, and servers, such as server 106. Network(s) 104 may include, for example and without limitation, a wide area network, a local area network, a private network, a public network, a packet network, a circuit-switched network, a wired network, and/or a wireless network.

As further shown in FIG. 1, user device 102 includes a plurality of interconnected components, including one or more processors 122, memory 126, one or more input devices 120, and one or more output devices 124. Each of these components will now be described.

Processor(s) 122 is intended to represent one or more microprocessors, each of which may comprise one or more central processing units (CPUs) or microprocessor cores. Processor(s) 122 may also be implemented using other types of integrated circuits. Processor(s) 122 operate in a well-known manner to execute computer programs (also referred to herein as computer program logic). The execution of such computer programs causes processor(s) 122 to perform operations including operations that will be described herein. Each of memory 126, input device(s) 120 and output device(s) 124 is connected to processor(s) 122 via one or more suitable interfaces.

Memory 126 comprises one or more computer-readable memory devices that operate to store computer programs and data. Memory 126 may include non-volatile memory as well as volatile memory. The non-volatile memory may be implemented using any of a wide variety of non-volatile computer-readable memory devices, including but not limited to, read-only memory (ROM) devices, solid state drives, hard disk drives, magnetic storage media such as magnetic disks and associated drives, optical storage media such as optical disks and associated drives, and flash memory devices such as USB flash drives. The volatile memory may be implemented using any of a wide variety of volatile computer-readable memory devices including, but not limited to, random access memory (RAM) devices.

Output device(s) 124 comprise devices via which user device 102 may output information to a user thereof. Output device(s) 124 may include, for example, and without limitation, a display and one or more speakers. Depending upon the implementation of user device 102, each output device 124 may be integrated within the same physical structure or housing as processor(s) 122 or may be physically separate from a structure or housing that includes processor(s) 122 and connected thereto via a suitable wired and/or wireless connection.

Input device(s) 120 comprise one or more devices that operate to generate user input information in response to a user's manipulation or control thereof. Such user input information is passed via a suitable interface to processor(s) 122 for processing thereby. Depending upon the implementation, input device(s) 120 may include a touch screen (e.g., a touch screen integrated with a display), a keyboard, a keypad, a mouse, a touch pad, a trackball, a joystick, a pointing stick, a wired glove, a motion tracking sensor, a game controller or gamepad, a microphone, or a video capture device such as a camera. However, these examples are not intended to be limiting and input device(s) 120 may include other types of devices other than those listed herein. Depending upon the implementation, each input device 120 may be integrated within the same physical structure or housing as processor(s) 122 (such as an integrated touch screen, touch pad, or keyboard on a mobile device) or may be physically separate from a physical structure or housing that includes processor(s) 122 and connected thereto via a suitable wired and/or wireless connection.

Although not shown in FIG. 1, user device 102 also includes one or more network interfaces that enable user device 102 to communicate over network(s) 104. For example, the network interface(s) may comprise a wired network interface such as an Ethernet interface or a wireless network interface such as an IEEE 802.11 (“Wi-Fi”) interface or a 3G telecommunication interface. However, these are examples only and are not intended to be limiting.

User device 102 may also include one or more sensors (not shown in FIG. 1). Such sensor(s) may comprise one or more devices that detect or sense physical stimulus (such as motion, light, heat, sound, pressure, magnetism, etc.) and generate a resulting signal (e.g., for measurement or control). Example sensors that may be included in user device 102 may include but are not limited to an accelerometer, a digital compass, a gyroscope, a Global Position System (GPS) sensor, a microphone, a camera, a pressure sensor associated with an input device such as a touch screen or keyboard/keypad, an electrodermal activity sensor or Galvanic Skin Response (GSR) sensor, and a heart rate sensor. Signals generated by the sensor(s) may be collected and processed by processor(s) 122 or other logic within user device 102 to support a variety of applications.

As further shown in FIG. 1, memory 126 stores a number of software components. These software components include a digital personal assistant 130, user activity tracking logic 132, task identification logic 134, and user availability determination logic 136. Each of these software components comprise computer program logic that can be executed by processor(s) 122 to perform various operations that will be described below.

Digital personal assistant 130 comprises a computer program that is configured to perform tasks, or services, for a user of user device 102. Examples of tasks that may be performed by digital personal assistant 130 on behalf of the user may include, but are not limited to, placing a phone call, launching an application, sending an e-mail or text message, playing music, scheduling a meeting or other event on a user calendar, obtaining directions to a location, obtaining a score associated with a sporting event, posting content to a social media web site or microblogging service, recording reminders or notes, obtaining a weather report, obtaining the current time, setting an alarm, obtaining a stock price, finding a nearby commercial establishment, performing an Internet search, or the like. Digital personal assistant 130 may also be referred to as an intelligent personal assistant, an intelligent software assistant, or a virtual personal assistant.

Digital personal assistant 130 is configured to provide a user interface by which a user can submit questions, commands, or other verbal input and by which responses to such input or other information may be delivered to the user. In one embodiment, the input may comprise user speech that is captured by one or more microphones of user device 102 (each of which may comprise one of input device(s) 120), although this example is not intended to be limiting and user input may be provided in other ways as well. The responses generated by digital personal assistant 130 may be made visible to the user in the form of text, images, or other visual content shown on a display of user device 102 (which may comprise one of output device(s) 124). Such visual content may be shown, for example, within a graphical user interface (GUI) of digital personal assistant 130 that is rendered to the display. The responses may also comprise computer-generated speech or other audio content that is played back via one or more speaker(s) (each of which may comprise one of output device(s) 124).

In an embodiment, digital personal assistant 130 is configured to automatically generate a reminder or notice to a user of a user device 102 about a task that the user wants or needs to perform, wherein the reminder or notice is generated based at least on a predicted period of user availability. As will be discussed below, this feature is supported by computer program logic executing on user device 102 (also referred to herein as client-side logic) as well as by computer program logic executing on server 106 (also referred to herein as server-side logic). The computer programs executing on user device 102 in support of this feature will first be described. Then, the computer programs executing on server 106 in support of this feature will be described.

Client-side User Activity Tracking. User activity tracking logic 132 comprises client-side logic that operates to collect data relating to activities performed by a user while operating or otherwise utilizing user device 102. User activity tracking logic 132 may also operate to collect data relating to activities performed by a user while operating or otherwise utilizing any of one or more connected user devices 110. Connected user devices(s) 110 are intended to represent any type of device that may be communicatively connected to user device 102 and pass data thereto. Connected user device(s) 110 may represent, for example, a wearable fitness device or activity tracker, a smart watch, smart glasses, a personal health monitoring device, or the like. Connected user device(s) 110 may also include any of the device types discussed above as examples of user device 102. However, these examples are by no mean limiting. The connection(s) between user device 102 and connected user device(s) 110 may be implemented using any of a wide variety of peer-to-peer or network-based communication technologies (e.g., BLUETOOTH®, NFC, IEEE 802.11, Ethernet, USB, or the like).

The user activity data collected by user activity tracking logic 132 may be used for a number of purposes. For example, such user activity data may be used to obtain an estimate of how long it takes the user to complete certain tasks, or certain types of tasks. This data may be passed to server 106 where it may be used to generate a user-specific task completion time model as will be discussed below. By way of example, data that may be collected by user activity tracking logic 132 may include, but is by no means limited to, time spent by the user on phone calls with a particular person, time spent by the user working on a particular e-mail, word processing document, spreadsheet, or the like, time spent by the user browsing online content or conducting an online transaction, or time spent by the user utilizing a particular device, application, or service. As another example, sensor data obtained by user device 102 or by any of connected user device(s) 110 may be used to determine how long it takes the user to travel between particular locations, how long the user spends exercising, or the like. As will be appreciated by persons skilled in the relevant art(s), any of a wide variety of data relating to activities performed by the user while using user device 102 or connected user device(s) 110 can be collected and used to infer an amount of time that it takes the user to perform a particular task, or type of task.

The user activity data collected by user activity tracking logic 132 may also be used to identify new tasks to be performed by the user as will be discussed below. For example, data collected by user activity tracking logic 132 may be used to identify a task that is performed repeatedly or habitually by the user (e.g., a weekly phone call to a parent, exercising three times a week, an online news source that is visited periodically by the user, etc.). Such information may then form the basis for new tasks about which the user can be reminded (e.g., helping the user find time for the weekly phone call to the parent, the exercise session, or the visit to the online news source).

The user activity data collected by user activity tracking logic 132 may further be used to help determine if the user is currently available to perform a task as will be discussed below. For example, data collected by user activity tracking logic 132 may indicate that the user is currently busy (e.g., engaged in a phone call or online meeting, actively working on an e-mail, document or spreadsheet, exercising, consuming media content, driving in traffic, or the like) and is thus unavailable to perform a task. Data collected by user activity tracking logic 132 may likewise indicate that the user is currently unoccupied (e.g., aimlessly browsing the Internet or media content, disengaged from using devices/application/services, or the like) and is thus available to perform a task.

Client-side Task Identification. Task identification logic 134 comprises client-side logic that is configured to automatically identify new tasks to be performed by a user of user device 102. Task identification logic 134 is further configured to provide information about the new tasks to server 106 so that they can be tracked thereby.

Task identification logic 134 may automatically identify new tasks in a variety of ways. For example, task identification logic 134 may be configured to identify new tasks by analyzing task information that is input by the user into user device 102 or any of connected user device(s) 110. For example, task identification logic 134 may be configured to identify new tasks by analyzing information about tasks that the user inputs into one or more productivity applications such as to-do lists, notes, calendar applications, or the like. Tasks identification logic 134 may also be configured to identify new tasks by analyzing information about tasks that the user inputs into other applications, such as word processing applications, spreadsheets, Web browsers, or the like.

As another example, task identification logic 134 may be configured to identify new tasks by analyzing one or more communications sent and/or received by the user via user device 102 or any of connected user device(s) 110. Such communications may include, for example and without limitation, unstructured communications such as e-mail, text messages, social media posts or messages or the like. Example techniques that may be implemented by task identification logic 134 to identify new tasks by analyzing communications sent and/or received by a user are described in the following commonly-owned and co-pending U.S. Patent Applications, the entirety of which are incorporated by reference herein: U.S. patent application Ser. No. 14/755,885 entitled “USER-SPECIFIC TASK REMINDER ENGINE”; U.S. patent application Ser. No. 14/714,109 entitled “MANAGEMENT OF COMMITMENTS AND REQUESTS EXTRACTED FROM COMMUNICATIONS AND CONTENT”; and U.S. patent application Ser. No. 14/714,137 entitled “AUTOMATIC EXTRACTION OF COMMITMENTS AND REQUESTS FROM COMMUNICATIONS AND CONTENT”. However, techniques other than those described in the aforementioned patent applications may be used to identify new tasks by analyzing communications sent and/or received by a user.

As yet another example, task identification logic 134 may be configured to identify new tasks by analyzing one or more previously-detected activities of a user. The previously-detected activities may be determined, for example, based on user activity information provided by user activity tracking logic 132. For example, task identification logic 134 may determine based on user activity information provided by user activity tracking logic 132 that a user has only partially completed a task. In further accordance with this example, task identification logic 132 may determine that the user has only partially consumed an item of media content (e.g., text content such as a news article, video content such as a television show or movie, or audio content such as a compilation of music or an audio book). As a result, task identification logic 132 may identify a new task that entails continuing or completing the consumption of the media content. In still further accordance with this example, task identification logic 132 may determine that the user has only partially completed an e-mail, a document, a spreadsheet or the like. As a result, task identification logic 132 may identify a new task that entails continuing or completing the e-mail, document or spreadsheet. Still other partially-completed tasks may be identified by task identification logic 134 and utilized as a basis for identifying new tasks.

Task identification logic 134 may also be configured to analyze user activity data collected by user activity tracking logic 132 to identify a task that is performed periodically or habitually by the user. Such information may then form the basis for new tasks about which the user can be reminded. Task identification logic 134 may be further configured to generate various metadata associated with the periodically-performed or habitually-performed activity that can then be used to schedule reminders and/or deadlines for newly-generated tasks. Such metadata may include, for example, and without limitation, a day, time, frequency, and/or location associated with the periodically-performed or habitually-performed activity.

In an alternate embodiment, any or all of the aforementioned operations of task identification logic 134 may instead by performed by task identification logic 152 that executes on server 106 based on information provided by user device 102 and/or other devices. In a further alternate embodiment, any or all of the aforementioned operations of task identification logic 134 may be performed in a joint or distributed fashion by both task identification logic 134 and task identification logic 152.

Client-side User Availability Determination. User availability determination logic 136 is client-side logic that is configured to determine whether or not a user of user device 102 is currently available to perform a task. User availability determination logic 136 is further configured to provide the results of such determination to server 106 for user thereby in selectively generating task reminders or notifications.

User availability determination logic 136 may determine whether or not a user of user device 102 is currently available to perform a task in a variety of ways. For example, user availability determination logic 136 may be configured to make such a determination based on user-specific calendar or appointment data obtained from an application or service utilized by the user.

As another example, user availability determination logic 136 may be configured to determine whether or not a user of user device 102 is currently available to perform a task based on user activity information received from user activity tracking logic 132. For example, based on user activity information received from user activity tracking logic 132, user availability determination logic 136 may determine that the user is currently busy (e.g., engaged in a phone call or online meeting, actively working on an e-mail, document or spreadsheet, exercising, consuming media content, driving in traffic, or the like) and is thus unavailable to perform a task. Furthermore, based on user activity information received from user activity tracking logic 132, user availability determination logic 136 may determine that the user is currently unoccupied (e.g., aimlessly browsing the Internet or media content, disengaged from using devices/application/services, or the like) and is thus available to perform a task.

User availability determination logic 136 may also infer that a user is occupied or unoccupied during a particular time period based on a detected pattern of behavior (e.g., a routine or habit) of the user. Thus, for example, if based on historical user activity data, it has been established that the user usually goes to bed at a particular time and wakes up at a particular time, then user availability determination logic 136 may infer that the user will be unavailable at any time between those times. As another example, if based on historical user activity data, it has been established that the user exercises during the same time period on most days, then user availability determination logic 136 may infer that the user be unavailable during that time period.

User availability determination logic 136 may also use sensor data or other signals provided by user device 102 or any of connected user device(s) 110 to determine whether or not a user is in a suitable state of mind for performing a task. For example, such data may indicate that a user is under stress or tired and thus not in a suitable state of mind for performing a task. A variety of signals that may be obtained from a device and techniques for using such signals to automatically assess a user's mental and/or emotional state are described in commonly-owned, co-pending U.S. patent application Ser. No. 14/315,049, filed Jun. 25, 2014, and entitled “LEVERAGING USER SIGNALS FOR IMPROVED INTERACTIONS WITH DIGITAL PERSONAL ASSISTANT,” the entirety of which is incorporated by reference therein. As described in that patent application, any of the following signals may be used to help determine a user's mental or emotional state: facial expressions of the user; voice characteristics of the user; a location of the user; a rate at which the user is turning on and off a mobile device; keystroke and/or gesture metadata associated with the user; written and/or spoken content of the user; application interaction metadata associated with the user; accelerometer, compass, and/or gyroscope output; degree of exposure to light; temperature; weather conditions; traffic conditions; pollution and/or allergen levels; activity level of the user; heart rate and heart rate variability of the user; electrodermal activity of the user; device and/or network connection information for a device associated with the user; and battery and/or charging information for a device associated with the user.

As noted above, in an embodiment, user availability determination logic 136 is configured to determine whether or not a user of user device 102 is currently available to perform a task and to provide the results of such determination to server 106 for use thereby in selectively generating task reminders/notices. In an alternate embodiment, user availability determination logic 136 may be configured to instead provide “raw” data (e.g., user activity data, sensor data, or other signals) to server 106 and server 106 may instead make the ultimate determination as to whether or not the user is currently available.

Computer program logic that executes on server 106 in support of the task identification and notification features of digital personal assistant 130 will now be described. As shown in FIG. 1, server 106 comprises one or more processors 140 that are connected to memory 142 via a suitable interface. Processor(s) 140 and memory 142 may be respectively implemented in a like manner to processor(s) 122 and memory 126 as described above in reference to user device 102, and thus need not be further described. Memory 142 stores a number of software components including user activity tracking logic 150, task identification logic 152, user availability determination logic 154, reminder generation logic 156, task tracking logic 158 and task completion time model generation logic 160. Each of these software components comprise computer program logic that can be executed by processor(s) 122 to perform various operations that will be described below.

Server-side User Activity Tracking. User activity tracking logic 150 comprises server-side logic that operates to collect data relating to activities performed by a user while operating or otherwise utilizing user device 102, as well as data relating to activities performed by a user while operating or otherwise utilizing other user devices, such as a user device 108. As shown in FIG. 1, user device 108 is also communicatively connected to server 106 via network(s) 104. By collecting data relating to activities performed by a user across multiple devices, user activity tracking logic 150 can obtain an even more accurate view of a user's activities. For example, user activity tracking logic 150 may be capable of collecting user activity data from each of a user's smart phone, desktop PC and gaming console. User activity tracking logic 150 may also be configured to communicate with one or more servers to collect data relating to activities performed by a user with respect to one or more online applications or services.

Like the user activity data collected by user activity tracking logic 132, the user activity data collected by user activity tracking logic 150 may be used for a number of purposes. For example, such user activity data may be used to obtain an estimate of how long it takes the user to complete certain tasks, or certain types of tasks. This data may then be used by server 106 to generate a user-specific task completion time model as will be discussed below. The user activity data collected by user activity tracking logic 150 may also be used to identify new tasks to be performed by the user (e.g., based on repeated or habitual tasks or behaviors) and to help determine if the user is currently available to perform a task.

Server-side Task Identification. Task identification logic 152 comprises server-side logic that is configured to automatically identify new tasks to be performed by a user of user device 102. Task identification logic 152 is further configured to provide information about the new tasks to task tracking logic 158 so that such new tasks can be tracked thereby.

Task identification logic 152 may automatically identify new tasks in a variety of ways. For example, task identification logic 152 may be configured to identify new tasks by analyzing task information that is input by the user into user device 102, user device 108, or an online application or service. For example, task identification logic 152 may be configured to identify new tasks by analyzing information about tasks that a user inputs into one or more productivity applications such as to-do lists, notes, calendar applications, or the like. Tasks identification logic 152 may also be configured to identify new tasks by analyzing information about tasks that the user inputs into other applications, such as word processing applications, spreadsheets, Web browsers, or the like.

As another example, task identification logic 152 may be configured to identify new tasks by analyzing one or more communications sent and/or received by the user via user device 102, user device 108, or via an online application or service. Such communications may include, for example and without limitation, unstructured communications such as e-mail, text messages, social media posts or messages or the like. Example techniques that may be implemented by task identification logic 152 to identify new tasks by analyzing communications sent and/or received by a user are described in the following commonly-owned and co-pending U.S. Patent Applications, the entirety of which are incorporated by reference herein: U.S. patent application Ser. No. 14/755,885 entitled “USER-SPECIFIC TASK REMINDER ENGINE”; U.S. patent application Ser. No. 14/714,109 and entitled “MANAGEMENT OF COMMITMENTS AND REQUESTS EXTRACTED FROM COMMUNICATIONS AND CONTENT”; and U.S. patent application Ser. No. 14/714,137 entitled “AUTOMATIC EXTRACTION OF COMMITMENTS AND REQUESTS FROM COMMUNICATIONS AND CONTENT”. However, techniques other than those described in the aforementioned patent applications may be used to identify new tasks by analyzing communications sent and/or received by a user.

As yet another example, task identification logic 152 may be configured to identify new tasks by analyzing one or more previously-detected activities of a user. The previously-detected activities may be determined, for example, based on user activity information provided by user activity tracking logic 132 and/or user activity tracking logic 150. For example, task identification logic 152 may determine based on user activity information provided by user activity tracking logic 132 and/or user activity tracking logic 150 that a user has only partially completed a task. As a result, task identification logic 150 may identify a new task that entails continuing or completing the partially-completed task.

Task identification logic 152 may also be configured to analyze user activity data collected by user activity tracking logic 132 and/or user activity tracking logic 150 to identify a task that is performed periodically or habitually by the user. Such information may then form the basis for new tasks about which the user can be reminded. Task identification logic 152 may be further configured to generate various metadata associated with the periodically-performed or habitually-performed activity that can then be used to schedule reminders and/or deadlines for newly-generated tasks (e.g., a day, time, frequency and/or location associated with the periodically-performed or habitually-performed activity).

Server-side User Availability Determination. User availability determination logic 154 is server-side logic that is configured to determine whether or not a user of user device 102 is currently available to perform a task. User availability determination logic 154 is further configured to provide the results of such determination to reminder generation logic 156 for use thereby in selectively generating task reminders or notifications.

User availability determination logic 154 may determine whether or not a user of user device 102 is currently available to perform a task in a variety of ways. For example, user availability determination logic 154 may be configured to make such a determination based on user-specific calendar or appointment data obtained from an application or service utilized by the user.

As another example, user availability determination logic 154 may be configured to determine whether or not a user of user device 102 is currently available to perform a task based on user activity information received from user activity tracking logic 132, user activity tracking logic executing on another user device (e.g., user device 108), and/or user activity tracking logic 150. For example, based on such user activity information, user availability determination logic 154 may determine that the user is currently busy and is thus unavailable to perform a task. Furthermore, based on such user activity information, user availability determination logic 154 may determine that the user is currently unoccupied and is thus available to perform a task.

User availability determination logic 154 may also infer that a user is occupied or unoccupied during a particular time period based on a detected pattern of behavior (e.g., a routine or habit) of the user.

User availability determination logic 154 may also use sensor data or other signals provided by user device 102 or user device 108 to determine whether or not a user is in a suitable state of mind for performing a task. For example, such data may indicate that a user is under stress or tired and thus not in a suitable state of mind for performing a task. A variety of signals that may be obtained from a device and techniques for using such signals to automatically assess a user's mental and/or emotional state are described in commonly-owned, co-pending U.S. patent application Ser. No. 14/315,049, filed Jun. 25, 2014, and entitled “LEVERAGING USER SIGNALS FOR IMPROVED INTERACTIONS WITH DIGITAL PERSONAL ASSISTANT,” the entirety of which is incorporated by reference therein.

Task Tracking Logic 158. Task tracking logic 158 comprises server-side logic that is configured to collect new tasks that are identified by task identification logic 134 and/or task identification logic 152 and to maintain such tasks until they are completed or deleted by a user. Task tracking logic 158 may also store various items of metadata associated with a task, including but not limited to a text description of the task, a deadline date and/or time associated with the task, a frequency associated with the task (e.g., if the task is a recurring task), a description or list of one or more entities (people, business organizations, or the like) associated with the task, a description or list of one or more deliverables associated with the task, or the like.

In certain embodiments, the various tasks that are being tracked by task tracking logic 158 may be presented to a user via a suitable user interface. For example, the tasks that are being tracked by task tracking logic 158 may be displayed within a calendar, to do list, note, or other suitable task-tracking interface. Such user interface may be presented, for example, by a Web browser or application executing on user device 102 based on information provided by task tracking logic 158.

To facilitate the selective generation of task reminders by reminder generation logic 156, task tracking logic 158 is also configured to obtain an estimate of an amount of time required to complete new tasks identified by task identification logic 134 and/or task identification logic 152. In an embodiment, task tracking logic 158 is configured to obtain an estimated completion time for a new task by applying a task completion time model 162 to the new task. The nature of task completion time model 162 and the manner of generating the same will be discussed below in reference to task completion time model generation logic 160.

Task Completion Time Model Generation. Task completion time model generation logic 160 comprises server-side logic that is configured to generate a task completion time model 162 that can be used by task tracking logic 158 to obtain an estimated completion time for each new task identified by task identification logic 134 and/or task identification logic 152.

Generally speaking, task completion time model 162 is a computer-implemented model that accepts as an input at least an identifier (e.g., a description) of a new task and provides as an output at least an estimated time to complete the new task. Task completion time model 162 may be obtained or generated in a variety of ways.

In one embodiment, task completion time model 162 comprises a table or other data structure that associates each of a plurality of different task types with a corresponding estimated completion time. In accordance with such an embodiment, an estimated completion time for a new task may be obtained by identifying one or more similar or related task types from among the plurality of different task types and then calculating the estimated completion time for the new task based on the completion time(s) associated with the similar or related task(s). However, this is only one example, and task completion time model 162 may be significantly more complex.

For example, in an alternate embodiment, task completion time model 162 may comprise a task completion time model generated by a machine learning algorithm that receives as input a new task and a set of features that are analyzed to determine an estimated completion time for the new task. The features may comprise an extremely diverse set of signals that can be obtained, for example, from user device 102 or user device 108.

In one embodiment, task completion time model 162 comprises a non-user-specific task completion time model. For example, task completion time model 162 may be generated based on data that specifies a time that it takes an average person to complete each of a plurality of different tasks.

In a further embodiment, task completion time model 162 comprises a model that is selected from a plurality of different non-user-specific task completion time models. For example, a different non-user-specific task completion time model may be generated for each of a plurality of different demographic groups. In accordance with such an embodiment, task completion time model generation logic 160 determines that a user of user device 102 belongs to a particular one of the demographic groups and then selects the non-user-specific task completion time model for that group as task completion time model 162. In a further embodiment, if task completion time model generation logic 160 determines that the user of user device 102 belongs to multiple demographic groups, it may generate task completion time model 162 by combining the task completion time models for those groups (e.g., by weighting estimated completion times output by each model and summing the weighted values).

In another embodiment, task completion time model 162 comprises a user-specific task completion time model. For example, task completion time model 162 may be generated based on data collected from user device 102 and/or user device 108, wherein such data is associated with the performance of one or more tasks by the user thereof. In further accordance with such an embodiment, task completion time tracking logic 170 (which comprises part of task tracking logic 158) is configured to identify a completion time associated with a task tracked by task tracking logic 158 when such task is deemed complete. Task completion time tracking logic 170 may then provide the completion time for the task to task completion time model generation logic 160 so that task completion time model generation logic 160 can update task completion time model 162 based on this new data. In this manner, as a user completes more and more tasks, more data can be collected about different types of tasks and about how long it takes the user to complete such tasks, and such data can be used to improve task completion time model 162.

For example, assume that the task “write history report” is being tracked by task tracking logic 158. Based on user activity information obtained from user activity tracking logic 132 and/or user activity tracking logic 150, task completion time tracking logic 170 may determine the amount of time it takes a user to complete the “write history report” task by adding together an amount of time the user spent conducting online research about the topic of the history paper and an amount of time the user spent entering text into the history report document. This completion time may then be fed to task completion time model generation logic 160 and used to update task completion time model 162, such that task completion time model 162 will be better able to predict how long it will take the user to write a history report in the future. Of course, this is merely one example of how task completion time data collected for a user can be used to update task completion time model 162.

In an embodiment, task completion time model generation logic 160 is configured to use a non-user-specific task completion time model as an initial version of task completion time model 162. Then, as user-specific task completion time data is received from task completion time tracking logic 170, task completion time model generation logic 160 utilizes such data to update task completion time model 162, thereby generating a user-specific task completion time model for the user.

In another embodiment, a machine learning algorithm is trained offline based on a corpus of data obtained from a large population of users to generate a non-user-specific task completion time model that is used as the initial version of task completion time model 162. Then, as user-specific task completion time data is received from task completion time tracking logic 170, such data is used as online input to the machine learning algorithm. Based on such online input, the machine learning algorithm updates task completion time model 162, thereby generating a user-specific task completion time model for the user.

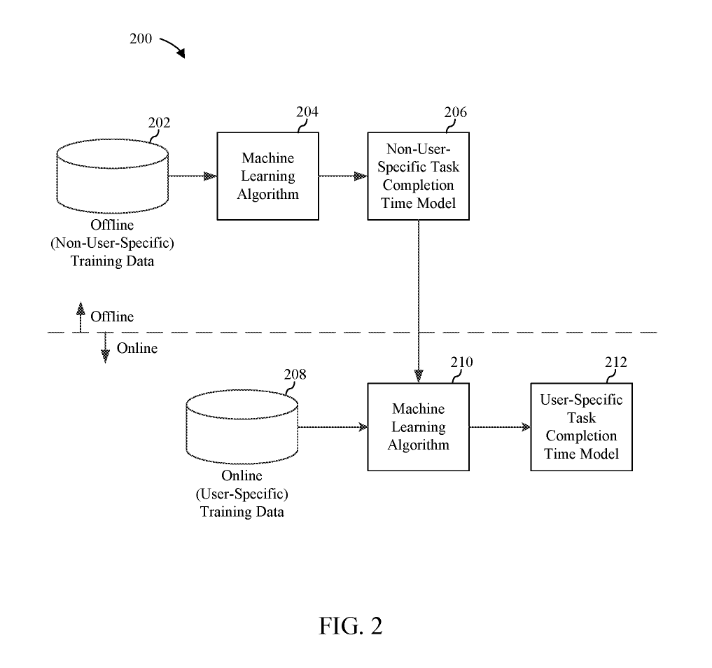

FIG. 2 is a block diagram of a system 200 that operates in this manner. As shown in FIG. 2, offline (non-user-specific) training data 202 is provided as input to a machine learning algorithm 204. Offline (non-user-specific) training data 202 may comprise information about tasks performed by a group of users (e.g., a very large group of users), the completion time associated with such tasks, as well as features or signals associated with the performance of those tasks. Based on this data, machine learning algorithm 204 may determine which features or signals are most significant in terms of predicting a completion time for a given task or task type. Machine learning algorithm 204 thereby generates a non-user-specific task completion time model 206. This model may be used as an initial version of task completion time model 162.

As further shown in FIG. 2, when a user is using system 100 of FIG. 1, online (user-specific) training data 208 is generated. Such training data may comprise, for example, task completion time data that is generated by task completion time tracking logic 170 in the manner described above as well as other features or signals associated with the performance of tasks by the user. This online (user-specific) training data 208 is provided as input to a machine learning algorithm 210 (which may be the same as machine learning algorithm 204 or different depending upon the implementation). Based on online (user-specific) training data 208, machine learning algorithm 210 updates non-user-specific task completion time model 206, thereby creating user-specific task completion time model 212. This model may then be used as an updated version of task completion time model 162.

Of course, the foregoing are merely only a few examples of how task completion time model generation 160 operates to generate task completion time model 162. It will be appreciated by persons skilled in the relevant art(s) that still other techniques may be used.

Reminder Generation. Reminder generation logic 156 comprises server-side logic that is configured to selectively cause reminders or notifications about tasks being tracked by task tracking logic 158 to be presented to a user of user device 102. In an embodiment, reminder generation logic 156 performs this function by identifying a period of user availability and then determining whether the period of user availability is suitable for performing at least a portion of a task being tracked by task tracking logic 158. If reminder generation logic 156 determines that the period of user availability is suitable for performing at least a portion of the task, then reminder generation logic 156 causes a reminder or notice about the task to be presented to the user.

Reminder generation logic 156 may be configured to identify a period of user availability in a variety of different ways. For example, reminder generation logic 156 may be configured to identify a period of user availability based on a user availability determination or assessment received from user availability determination logic 136 and/or user availability determination logic 154. Various criteria that may be used in making such a determination or assessment are set forth above in the sections corresponding to those components. In addition, reminder generation logic 156 may be configured to identify a period of user availability based on one or more of the following factors (some of which may also be used by user availability determination logic 136 and user availability determination logic 154): user calendar or appointment data obtained from an application or service utilized by the user; data that identifies a current location of the user; data concerning usage of an application, service or device (e.g., any of user device 102, user device 108, and connected user device(s) 110) by the user, or sensor data obtained by a device associated with the user (e.g., sensor data obtained by any of user device 102, user device 108, and connected user device(s) 110). Still other factors or criteria may be used by reminder generation logic 156 in identifying a period of user availability.

Once a period of user availability has been identified, reminder generation logic 156 then determines whether such period of user availability is suitable for performing a particular task being tracked by task tracking logic 158.

In an embodiment, reminder generation logic 156 is configured to determine that an identified period of user availability is suitable for performing a task when the period of user availability equals or exceeds an estimate of the amount of time required to perform the task. As noted above, such estimate may be maintained by task tracking logic 158 in association with the task and obtained therefrom by reminder generation logic 156. Thus, reminder generation logic 158 can advantageously remind a user about a task during a period of user availability that is likely to be long enough to allow the user to complete the task.

In a further embodiment, reminder generation logic 158 may be configured to identify a current period of user availability as well as one or more future periods of user availability. In accordance with such an embodiment, reminder generation logic 158 may be configured to determine that the current period of user availability is suitable for performing at least a portion of a task by determining that the current period of user availability in combination with the one or more future periods of user availability equals or exceeds an estimate of the amount of time required to perform the task. Thus, reminder generation logic 158 can advantageously remind a user about a task across several time periods that, when taken together, are sufficiently long enough for the user to complete the task.

Reminder generation logic 158 may be configured to take other factors into account in addition to or other than the estimated completion time when determining whether a period of user availability is suitable for performing a task. For example, depending upon the implementation, reminder generation logic 158 may make a suitability determination based on any or all of the following factors: a mental or emotional state of the user, resources currently available or unavailable to the user, user habits, user preferences, and imminence of a deadline associated with the task. Still other factors may be considered. Furthermore, some or all of these factors may be subsumed within the user availability determination rendered by user availability determination logic 136 and/or user availability determination logic 154.

Once reminder generation logic 158 has determined that a period of user availability is suitable for performing a particular task, reminder generation logic 158 causes a notice or reminder about the task to be presented to the user of user device 102. In one embodiment, reminder generation logic 158 is configured to perform this function by transmitting the relevant task information to user device 102. In response, digital personal assistant 130 presents a notice or reminder about the task to the user based on the relevant task information. Such notice or reminder may be presented visually (e.g., shown in a GUI of digital personal assistant 130 that is rendered to a display of user device 102), audibly (e.g., played back via one or more speakers of user device 102), or both. Other type of sensory feedback (e.g., haptic feedback) may also be used to alert the user to the notice or reminder. Reminder generation logic 158 may also cause the notice or reminder to be presented on other devices as well (e.g., user device 108 or any of connected user device(s) 110).

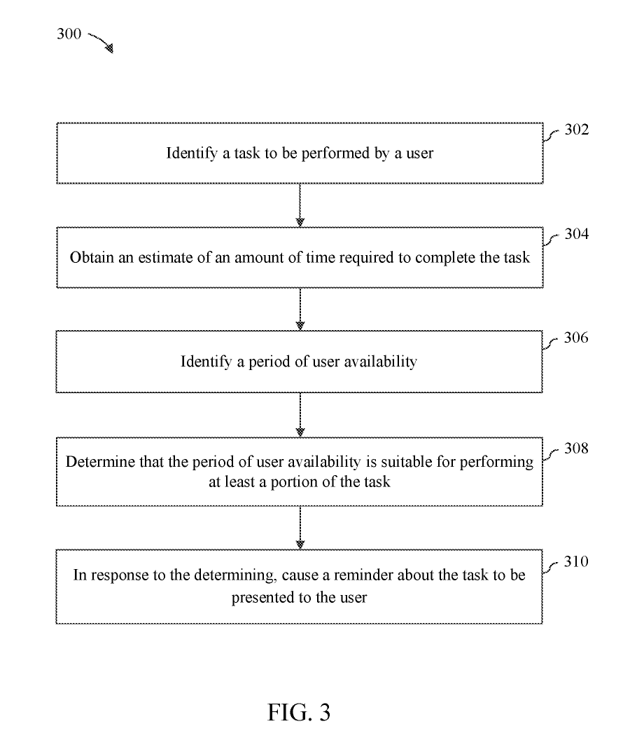

The manner of operation of system 100 will now be further described in reference to FIG. 3. In particular, FIG. 3 is a flowchart 300 of a method that may be performed by system 100 in accordance with an embodiment. Although the method of flowchart 300 is described with continued reference to various components of system 100, it will be appreciated that the method of flowchart 300 may be performed by other components or systems entirely.

As shown in FIG. 3, the method of flowchart 300 begins at step 302, in which a task to be performed by a user is identified. This step may be performed, for example, by task identification logic 134 and/or task identification logic 152 in a manner described above. For example, as discussed above, either of these components may identify the task to be performed by the user based on one or more of an analysis of one or more communications sent and/or received by the user, an analysis of one or more previously-detected activities of the user, and task information input by the user. In one embodiment discussed above, the previously-detected activities include a partial completion of a task by the user. In another embodiment discussed above, task identification logic 134 and/or task identification logic 152 identify the task to be performed by the user by identifying a habitual behavior of the user based on the analysis of the one or more previously-detected activities.

At step 304, an estimate of an amount of time required to complete the task is obtained. This step may be performed, for example, by task tracking logic 158 in a manner described above. For example, as discussed above, task tracking logic 158 may obtain an estimate of the amount of time required to complete the task by applying task completion time model 162 to the task. In one embodiment, task completion time model 162 is generated based at least in part on data that indicates how long it took the user to perform a same or similar task. For example, data about how long it took the user to perform a same or similar task may be collected by task completion time tracking logic 170 and provided to task completion time model generation logic 160 for use thereby in generating a user-specific task completion time model. In another embodiment, task completion time model 162 is generated based at least in part on data that indicates how long it took at least one other user to perform a same or similar task. For example, data concerning how long it took other users to perform a same or similar task may be collected offline and used to generate a non-user-specific task completion time model.

At step 306, a period of user availability is identified. This step may be performed, for example, by reminder generation logic 156 in a manner described above. For example, as discussed above, reminder generation logic 156 may identify a period of user availability based on one or more of: calendar or appointment data obtained from an application or service utilized by the user, data that identifies a current location of the user, data concerning usage of a device, application or service by the user, and sensor data obtained by a device associated with the user.

At step 308, it is determined that the period of user availability is suitable for performing at least a portion of the task. This step may be performed, for example, by reminder generation logic 156 in a manner described above. For example, as discussed above, reminder generation logic 156 may determine that the period of user availability is suitable for performing at least a portion of the task by determining that the period of user availability equals or exceeds the estimate of the amount of time required to perform the task. As another example, reminder generation logic 156 may identify one or more additional (e.g., future) periods of user availability, and then determine that the period of user availability is suitable for performing at least a portion of the task by determining that the period of user availability in combination with the one or more additional periods of user availability equals or exceeds the estimate of the amount of time required to perform the task. In further embodiments, reminder generation logic 156 may also determine that the period of user availability is suitable for performing at least a portion of the task by determining one or more of a mental and/or emotional state of the user, one or more resources currently available or unavailable to the user, user habits, user preferences, and imminence of a deadline associated with the task.

At step 310, in response to the determining of step 308, a reminder about the task is caused to be presented to the user. This step may be performed, for example, by reminder generation logic 156 in a manner described above. As discussed above, in one embodiment, reminder generation logic 156 causes the reminder to be presented to the user by digital personal assistant 130 executing on user device 102.

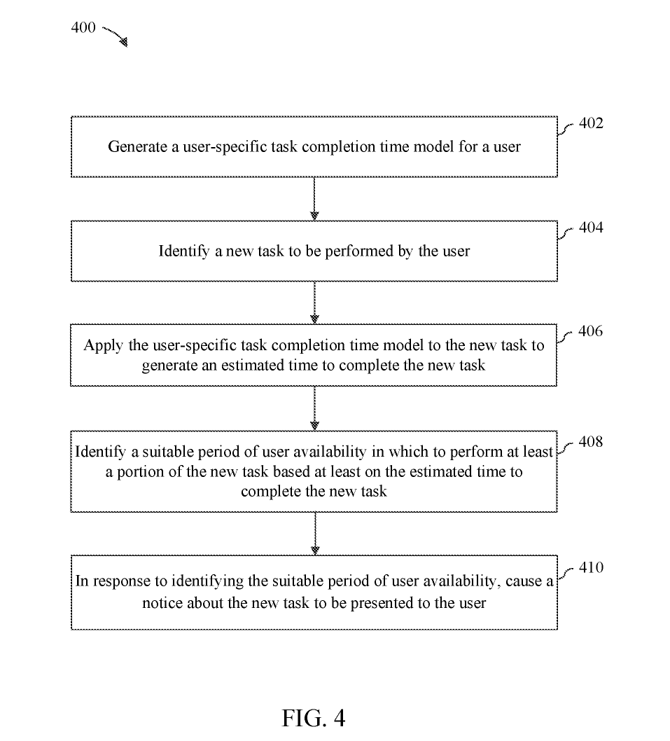

FIG. 4 is a flowchart 400 of a further method for automatically identifying and presenting tasks to a user based on predicted periods of user availability in accordance with an embodiment. Like the method of flowchart 300, the method of flowchart 400 may be performed by system 100. Although the method of flowchart 400 is described with continued reference to various components of system 100, it will be appreciated that the method of flowchart 400 may be performed by other components or systems entirely.

As shown in FIG. 4, the method of flowchart 400 begins at step 402, in which a user-specific task completion time model is generated for a user. This step may be performed, for example, by task completion time model generation logic 160 in a manner described above. For example, as discussed above, task completion time model generation logic 160 may generate the user-specific task completion time model by collecting data from one or more electronic devices (e.g., user device 102 and user device 108), the data being associated with the performance of one or more tasks by the user, and utilizing the data to generate the user-specific task completion time model for the user. Utilizing the data to generate the user-specific task completion time model for the user may comprise, for example, generating a table that associates each of one or more task types with a corresponding completion time or utilizing the data to train a machine learning algorithm that generates the user-specific task completion time model for the user. In a further embodiment, task completion time model generation logic 160 may generate the user-specific task completion time model by utilizing a non-user-specific task completion time model as an initial version of a task completion time model for the user, and updating the non-user-specific task completion time model based on data collected from one or more electronic devices (e.g., user device 102 and/or user device 108) the data being associated with the performance of one or more tasks by the user.

At step 404, a new task to be performed by the user is identified. This step may be performed, for example, by task identification logic 134 and/or task identification logic 152 in a manner described above.

At step 406, the user-specific task completion model is applied to the new task to generate an estimated time to complete the new task. This step may be performed, for example, by task tracking logic 158 in a manner described above. For example, as discussed above, task tracking logic 158 may perform this step by calculating the estimated time to complete the new task based on a completion time associated with each of one or more previous tasks determined to be related to the new task.

At step 408, a suitable period of user availability in which to perform at least a portion of the new task is identified based at least on the estimated time to complete the new task. This step may be performed, for example, by reminder generation logic 156 in a manner described above.

At step 410, in response to identifying the suitable period of user availability, a notice about the new task is caused to be presented to the user. This step may be performed, for example, by reminder generation logic 156 in a manner described above.

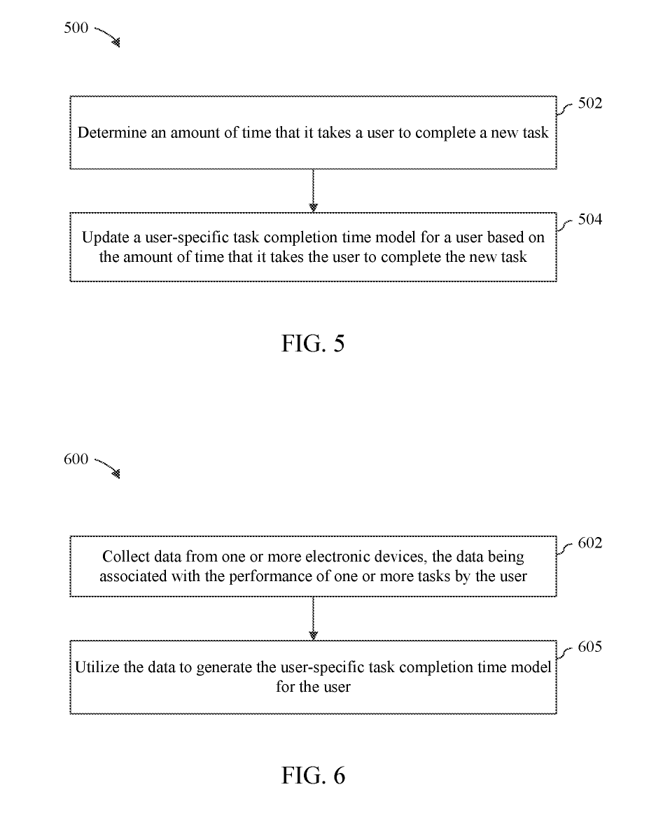

FIG. 5 is a flowchart 500 of a method for updating a user-specific task completion time model for a user in accordance with an embodiment. The steps of flowchart 500 may be performed, for example, by system 100 after performing the steps of flowchart 400 as described above in reference to FIG. 4.

As shown in FIG. 5, the method of flowchart 500 begins at step 502, in which an amount of time that it takes a user to complete a new task is determined. This step may be performed, by task completion time tracking logic 170 in a manner described above.

At step 504, a user-specific task completion time model for the user is updated based on the amount of time that it takes the user to complete the new task. This step may be performed, for example, by task completion time model generation logic 160 in a manner described above.

FIG. 6 is a flowchart 600 of one method for performing step 402 of flowchart 400 in accordance with an embodiment. As shown in FIG. 6, the method of flowchart 600 begins at step 602, in which data is collected from one or more electronic devices, the data being associated with the performance of one or more tasks by the user. This step may be performed, for example, by task completion time tracking logic 170 that collects data from one or more electronic devices (e.g., user device 102 and/or user device 108) associated with the performance of one or more tasks by the user.

At step 602, the data collected in step 602 is utilized to generate the user-specific task completion model for the user. This step may be performed, for example, by task completion time model generation logic 160 in a manner described above.

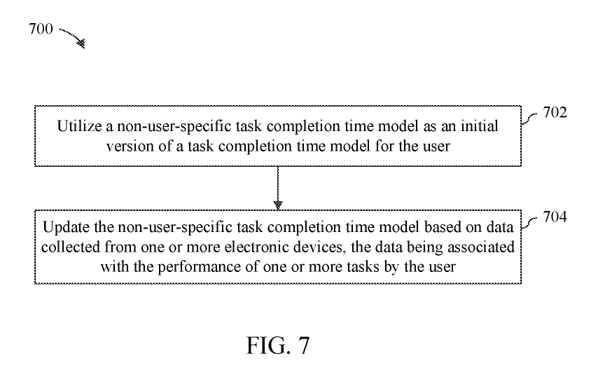

FIG. 7 is a flowchart 700 of a further method for performing step 402 of flowchart 400 in accordance with an embodiment. As shown in FIG. 7, the method of flowchart 700 begins at step 702 in which a non-user-specific task completion time model is utilized as an initial version of a task completion time model for the user. This step may be performed, for example, by task completion time model generation logic 160 in a manner described above.

At step 704, the non-user-specific task completion time model is updated based on data collected from one or more electronic devices, the data being associated with the performance of one or more tasks by the user. This step may also be performed, for example, by task completion time model generation logic 160 in a manner described above.

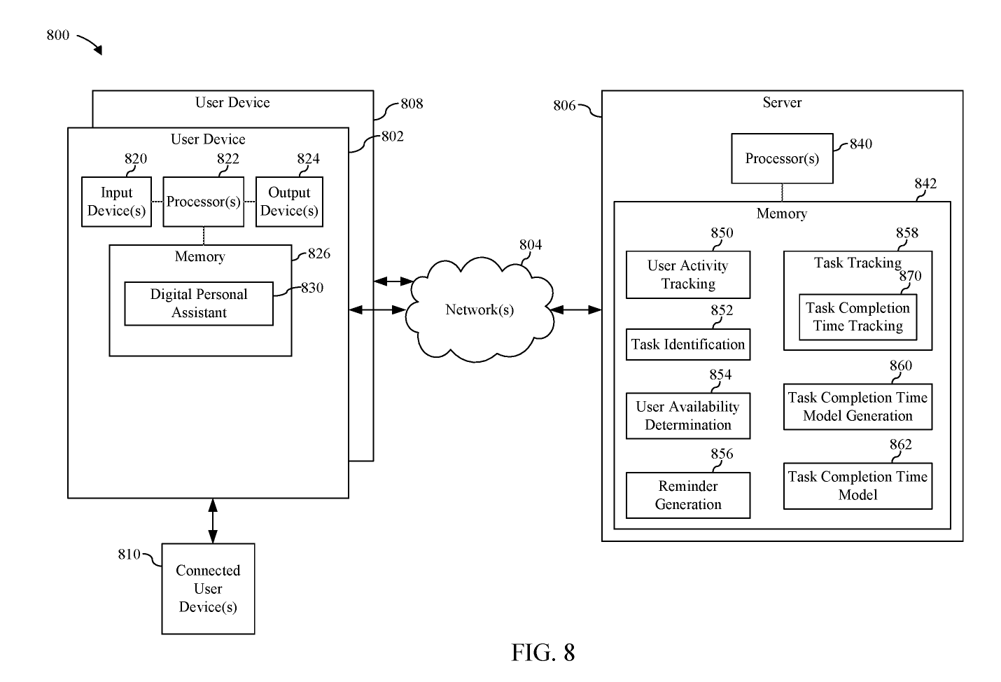

FIG. 8 is a block diagram of an example system 800 in accordance with an alternate embodiment that automatically identifies and presents tasks to a user based on predicted periods of user availability. As shown in FIG. 8, like system 100 of FIG. 1, system 800 includes a user device 802 that is communicatively connected to a server 806 via one or more networks 804. However, in system 800, the above-described task identification and notification features are largely supported by software executing on server 806, while a personal digital assistant executing on user device 802 merely presents reminders or notices about tasks as directed by such server-side software.

Thus, as shown in FIG. 8, user device 802 comprises one or more processors 822, one or more input devices 820, one or more output devices 824, and memory 826 that are analogous to processor(s) 122, input device(s) 120, output device(s) 124 and memory 126, respectively, of system 100 of FIG. 1. Memory 826 stores a digital personal assistant 830 that is executed by processor(s) 822 to perform operations, including the presentation of task reminders or notices, wherein such presentation is driven by server-side logic executing on server 806.

As further shown in FIG. 8, server 806 comprises one or more processors 840 and memory 842 that are analogous to processor(s) 140 and memory 142, respectively, of system 100 of FIG. 1. Memory 842 stores the following server-side components that are utilized to enable the automatic identification and tracking of tasks and the selective generation of reminders or notices about such tasks: user activity tracking logic 850, task identification logic 852, user availability determination logic 854, reminder generation logic 856, task tracking logic 858 (which includes task completion time tracking logic 870), task completion time model generation logic 860, and task completion time model 862. These components are analogous to like-named components of system 100 of FIG. 1 and thus operate in a substantially similar manner. However, these components each perform their respective functions without the assistance of client-side counterparts. Some of these components do, however, operate based on signals and information received from each of user device 802, a user device 808, and any of connected user device(s) 810 (wherein such information is relayed through user device 802).

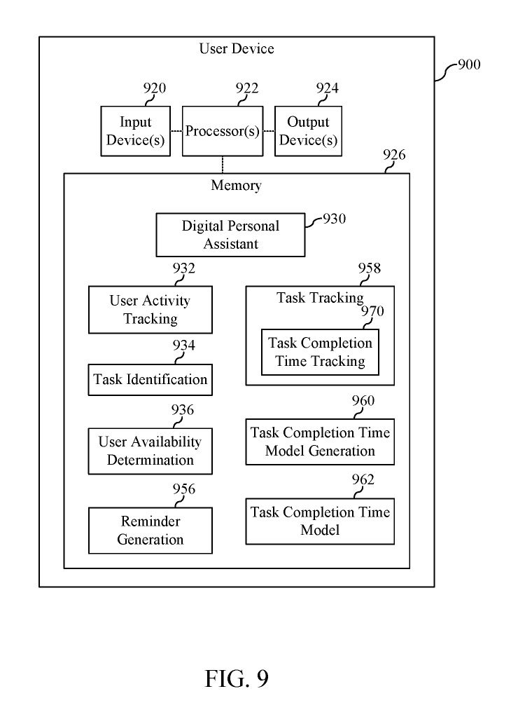

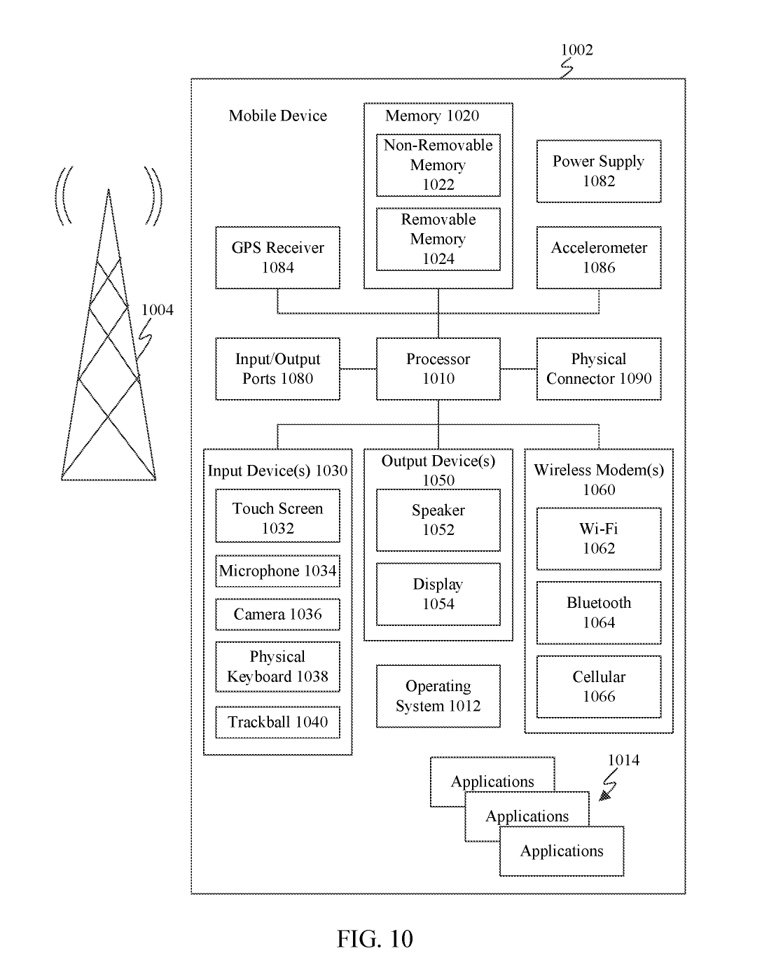

FIG. 9 is a block diagram of a user device 900 in accordance with an alternate embodiment that automatically identifies and presents tasks to a user based on predicted periods of user availability. As shown in FIG. 9, user device 900 includes all of the components necessary to perform the above-described task identification and notification features on a single device.

Thus, as shown in FIG. 9, user device 900 includes one or more processors 922, one or more input devices 920, one or more output devices 924, and memory 926 that are analogous to processor(s) 122, input device(s) 120, output device(s) 124 and memory 126, respectively, of system 100 of FIG. 1. Memory 926 stores the following components that are utilized to enable the automatic identification and tracking of tasks and the selective generation of reminders or notices about such tasks: a digital personal assistant 930, user activity tracking logic 932, task identification logic 934, user availability determination logic 936, reminder generation logic 956, task tracking logic 958 (which includes task completion time tracking logic 970), task completion time model generation logic 960, and task completion time model 962. These components are analogous to like-named components of system 100 of FIG. 1 and operate in a substantially similar manner. However, these components are capable of performing the above-described task identification and notification features without server support.

Although the above-described task identification and notification features are discussed as being associated with a digital personal assistant, it is to be understood that such features may be readily incorporated into any application or service that is accessible to a user. For example, such features may be incorporated into various productivity applications, such as a calendar application, a to-do list application, a notes application, or the like. However, these examples are not intended to be limiting.

Furthermore, in certain embodiments, a user (e.g. a user of user device 102, user device 802 or user device 902) may be provided with an option by which to opt out of activity tracking or various other features described above so as to avoid sharing personal data. In still other embodiments, a user may elect to enable only client-side activity tracking or various other features described above so as to restrict the user of personal data to a client device only.

III. Example Mobile Device Implementation

FIG. 10 is a block diagram of an exemplary mobile device 1002 that may implement embodiments described herein. For example, mobile device 1002 may be used to implement any of user device 102, user device 108 or connected user device(s) 110 as described above in reference to FIG. 1, user device 802, user device 808 or connected user device(s) 810 as described above in reference to FIG. 8, or user device 900 as described above in reference to FIG. 9. As shown in FIG. 10, mobile device 1002 includes a variety of optional hardware and software components. Any component in mobile device 1002 can communicate with any other component, although not all connections are shown for ease of illustration. Mobile device 1002 can be any of a variety of computing devices (e.g., cell phone, smartphone, handheld computer, Personal Digital Assistant (PDA), etc.) and can allow wireless two-way communications with one or more mobile communications networks 1004, such as a cellular or satellite network, or with a local area or wide area network.

The illustrated mobile device 1002 can include a controller or processor 1010 (e.g., signal processor, microprocessor, ASIC, or other control and processing logic circuitry) for performing such tasks as signal coding, data processing, input/output processing, power control, and/or other functions. An operating system 1012 can control the allocation and usage of the components of mobile device 1002 and provide support for one or more application programs 1014 (also referred to as “applications” or “apps”). Application programs 1014 may include common mobile computing applications (e.g., digital personal assistants, e-mail applications, calendars, contact managers, web browsers, messaging applications) and any other computing applications (e.g., word processing applications, mapping applications, media player applications).

The illustrated mobile device 1002 can include memory 1020. Memory 1020 can include non-removable memory 1022 and/or removable memory 1024. Non-removable memory 1022 can include RAM, ROM, flash memory, a hard disk, or other well-known memory devices or technologies. Removable memory 1024 can include flash memory or a Subscriber Identity Module (SIM) card, which is well known in GSM communication systems, or other well-known memory devices or technologies, such as “smart cards.” Memory 1020 can be used for storing data and/or code for running operating system 1012 and applications 1014. Example data can include web pages, text, images, sound files, video data, or other data to be sent to and/or received from one or more network servers or other devices via one or more wired or wireless networks. Memory 1020 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

Mobile device 1002 can support one or more input devices 1030, such as a touch screen 1032, a microphone 1034, a camera 1036, a physical keyboard 1038 and/or a trackball 1040 and one or more output devices 1050, such as a speaker 1052 and a display 1054. Other possible output devices (not shown) can include piezoelectric or other haptic output devices. Some devices can serve more than one input/output function. For example, touch screen 1032 and display 1054 can be combined in a single input/output device. The input devices 1030 can include a Natural User Interface (NUI).

Wireless modem(s) 1050 can be coupled to antenna(s) (not shown) and can support two-way communications between the processor 1010 and external devices, as is well understood in the art. The modem(s) 1060 are shown generically and can include a cellular modem 1066 for communicating with the mobile communication network 1004 and/or other radio-based modems (e.g., Bluetooth 1064 and/or Wi-Fi 1062). At least one of the wireless modem(s) 1060 is typically configured for communication with one or more cellular networks, such as a GSM network for data and voice communications within a single cellular network, between cellular networks, or between the mobile device and a public switched telephone network (PSTN).

Mobile device 1002 can further include at least one input/output port 1080, a power supply 1082, a satellite navigation system receiver 1084, such as a Global Positioning System (GPS) receiver, an accelerometer 1086, and/or a physical connector 1090, which can be a USB port, IEEE 1394 (FireWire) port, and/or RS-232 port. The illustrated components of mobile device 1002 are not required or all-inclusive, as any components can be deleted and other components can be added as would be recognized by one skilled in the art.

In an embodiment, mobile device 1002 is configured to perform any of the functions of any of user device 102, user device 108 or connected user device(s) 110 as described above in reference to FIG. 1, user device 802, user device 808 or connected user device(s) 810 as described above in reference to FIG. 8, or user device 900 as described above in reference to FIG. 9. Computer program logic for performing the functions of these devices may be stored in memory 1020 and executed by processor 1010. By executing such computer program logic, processor 1010 may be caused to implement any of the features of any of these devices. Also, by executing such computer program logic, processor 1010 may be caused to perform any or all of the steps of the flowcharts of FIGS. 3-7.

IV. Example Computer System Implementation

FIG. 11 depicts an example processor-based computer system 1100 that may be used to implement various embodiments described herein. For example, system 1100 may be used to implement any of user device 102, user device 108, connected user device(s) 110 or server 106 as described above in reference to FIG. 1, user device 802, user device 808, connected user device(s) 810 or server 806 as described above in reference to FIG. 8, or user device 900 as described above in reference to FIG. 9. System 1100 may also be used to implement any or all of the steps of the flowcharts of FIGS. 3-7. The description of system 1100 provided herein is provided for purposes of illustration, and is not intended to be limiting. Embodiments may be implemented in further types of computer systems, as would be known to persons skilled in the relevant art(s).

As shown in FIG. 11, system 1100 includes a processing unit 1102, a system memory 1104, and a bus 1106 that couples various system components including system memory 1104 to processing unit 1102. Processing unit 1102 may comprise one or more microprocessors or microprocessor cores. Bus 1106 represents one or more of any of several types of bus structures, including a memory bus or memory controller, a peripheral bus, an accelerated graphics port, and a processor or local bus using any of a variety of bus architectures. System memory 1104 includes read only memory (ROM) 1108 and random access memory (RAM) 1110. A basic input/output system 1112 (BIOS) is stored in ROM 1108.

System 1100 also has one or more of the following drives: a hard disk drive 1114 for reading from and writing to a hard disk, a magnetic disk drive 1116 for reading from or writing to a removable magnetic disk 1118, and an optical disk drive 1120 for reading from or writing to a removable optical disk 1122 such as a CD ROM, DVD ROM, BLU-RAY™ disk or other optical media. Hard disk drive 1114, magnetic disk drive 1116, and optical disk drive 1120 are connected to bus 1106 by a hard disk drive interface 1124, a magnetic disk drive interface 1126, and an optical drive interface 1128, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 1130, one or more application programs 1132, other program modules 1134, and program data 1136. In accordance with various embodiments, the program modules may include computer program logic that is executable by processing unit 1102 to perform any or all of the functions and features of any of user device 102, user device 108, connected user device(s) 110 or server 106 as described above in reference to FIG. 1, user device 802, user device 808, connected user device(s) 810 or server 806 as described above in reference to FIG. 8, or user device 900 as described above in reference to FIG. 9. The program modules may also include computer program logic that, when executed by processing unit 1102, performs any of the steps or operations shown or described in reference to the flowcharts of FIGS. 3-7.

A user may enter commands and information into system 400 through input devices such as a keyboard 1138 and a pointing device 1140 (e.g., a mouse). Other input devices (not shown) may include a microphone, joystick, game controller, scanner, or the like. In one embodiment, a touch screen is provided in conjunction with a display 1144 to allow a user to provide user input via the application of a touch (as by a finger or stylus for example) to one or more points on the touch screen. These and other input devices are often connected to processing unit 1102 through a serial port interface 1142 that is coupled to bus 1106, but may be connected by other interfaces, such as a parallel port, game port, or a universal serial bus (USB). Such interfaces may be wired or wireless interfaces.

Display 1144 is connected to bus 1106 via an interface, such as a video adapter 1146. In addition to display 1144, system 1100 may include other peripheral output devices (not shown) such as speakers and printers.

System 1100 is connected to a network 1148 (e.g., a local area network or wide area network such as the Internet) through a network interface 1150, a modem 1152, or other suitable means for establishing communications over the network. Modem 1152, which may be internal or external, is connected to bus 1106 via serial port interface 1142.

As used herein, the terms “computer program medium,” “computer-readable medium,” and “computer-readable storage medium” are used to generally refer to memory devices or storage structures such as the hard disk associated with hard disk drive 1114, removable magnetic disk 1118, removable optical disk 1122, as well as other memory devices or storage structures such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1132 and other program modules 1134) may be stored on the hard disk, magnetic disk, optical disk, ROM, or RAM. Such computer programs may also be received via network interface 1150, serial port interface 1142, or any other interface type. Such computer programs, when executed or loaded by an application, enable system 1100 to implement features of embodiments discussed herein. Accordingly, such computer programs represent controllers of the system 1100.

Embodiments are also directed to computer program products comprising software stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

In alternative implementations, system 1100 may be implemented as hardware logic/electrical circuitry or firmware. In accordance with further embodiments, one or more of these components may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

V Additional Exemplary Embodiments

A method implemented by at least one computing device is described herein.

The method includes: generating a user-specific task completion time model for a user; identifying a new task to be performed by the user; applying the user-specific task completion time model to the new task to generate an estimated time to complete the new task; identifying a suitable period of user availability in which to perform at least a portion of the new task based at least on the estimated time to complete the new task; and in response to identifying the suitable period of user availability, causing a notice about the new task to be presented to the user.

In one embodiment of the foregoing method, generating the user-specific task completion time model for the user comprises: collecting data from one or more electronic devices, the data being associated with the performance of one or more tasks by the user; and utilizing the data to generate the user-specific task completion time model for the user. In accordance with such an embodiment, utilizing the data to generate the user-specific task completion time model for the user may comprise generating a table that associates each of one or more task types with a corresponding completion time. In further accordance with such an embodiment, utilizing the data to generate the user-specific task completion time model for the user may comprise utilizing the data to train a machine learning algorithm that generates the task completion time model for the user.

In another embodiment of the foregoing method, generating the user-specific task completion time model for the user comprises: utilizing a non-user-specific task completion time model as an initial version of a task completion time model for the user; and updating the non-user-specific task completion time model based on data collected from one or more electronic devices, the data being associated with the performance of one or more tasks by the user.

In yet another embodiment of the foregoing method, applying the user-specific task completion time model to the new task to generate the estimated time to complete the new task comprises calculating the estimated time to complete the new task based on a completion time associated with each of one or more previously-completed tasks determined to be related to the new task.

In still another embodiment of the foregoing method, the method further comprises determining an amount of time that it takes the user to complete the new task; and updating the user-specific task completion model for the user based on the amount of time that it takes the user to complete the new task.

A system is also described herein. The system includes one or more processors; and memory that stores computer program logic for execution by the one or more processors. The computer program logic includes task identification logic, task tracking logic and reminder generation logic. The task identification logic is configured to identify a task to be performed by a user. The task tracking logic is configured to obtain an estimate of an amount of time required to complete the task. The reminder generation logic is configured to identify a period of user availability, to determine that the period of user availability is suitable for performing at least a portion of the task, the determining being based at least in part on the estimate of the amount of time required to complete the task, and in response to the determining, to cause a reminder about the task to be presented to the user.

In one embodiment of the foregoing system, the task identification logic is configured to identify the task to be performed by the user based on one or more of: an analysis of one or more communications sent and/or received by the user, an analysis of one or more previously-detected activities of the user, and task information input by the user. In accordance with such an embodiment, the previously-detected activities may comprise a partial completion of a task. In further accordance with such an embodiment, the task identification logic may be configured to identify the task to be performed by the user by identifying a habitual behavior of the user based on the analysis of the one or more previously-detected activities of the user.

In another embodiment of the foregoing system, the reminder generation logic is configured to identify the period of user availability based on one or more of: calendar or appointment data obtained from an application or service utilized by the user, data that identifies a current location of the user, data concerning usage of a device, application or service by the user, and sensor data obtained by a device associated with the user.

In yet another embodiment of the foregoing system, the task tracking logic is configured to obtain the estimate of the amount of time required to complete the task by applying a task completion time model to the task, the task completion time model being generated based at least in part on data that indicates how long it took the user to perform a same or similar task.

In still another embodiment of the foregoing system, the task tracking logic is configured to obtain the estimate of the amount of time required to complete the task by applying a task completion time model to the task, the task completion time model being generated based at least in part on data that indicates how long it took at least one other user to perform a same or similar task.

In a further embodiment of the foregoing system, the reminder generation logic is configured to determine that the period of user availability is suitable for performing the at least a portion of the task by determining that the period of user availability equals or exceeds the estimate of the amount of time required to perform the task.

In a still further embodiment of the foregoing system, the reminder generation logic is further configured to identify one or more additional periods of user availability, and wherein the reminder generation logic is configured to determine that the period of user availability is suitable for performing the at least a portion of the task by determining that the period of user availability in combination with the one or more additional periods of user availability equals or exceeds the estimate of the amount of time required to perform the task.

In another embodiment of the foregoing system, the reminder generation logic is further configured to determine that the period of user availability is suitable for performing the at least a portion of the task by determining one or more of: a mental and/or emotional state of the user, one or more resources currently available or unavailable to the user, user habits, user preferences, and imminence of a deadline associated with the task.

In yet another embodiment of the foregoing system, the reminder generation logic is configured to cause the reminder about the task to be presented to the user by causing the reminder about the task to be presented to the user by a digital personal assistant executing on a device.

A computer program product is also described herein. The computer program product comprises a computer-readable medium having computer program logic recorded thereon that, when executed by one or more processors, causes the one or more processors to perform a method for generating task reminders for a user. The computer program logic comprises: first computer program logic that, when executed by the one or more processors, identifies a task to be performed by a user; second computer program logic that, when executed by the one or more processors, applies a user-specific task completion time model to the task to obtain an estimate of an amount of time required to complete the task; third computer program logic that, when executed by the one or more processors, identifies a period of user availability; and fourth computer program logic that, when executed by the one or more processors, determines that the period of user availability is suitable for performing at least a portion of the task, the determining being based at least in part on the estimate of the amount of time required to complete the task, and in response to the determining, causes a reminder about the task to be presented to the user.

In one embodiment of the foregoing computer program product, the computer program logic further comprises: fifth computer program logic that, when executed by the one or more processors, determines a completion time for the task after the user has performed the task and updates the user-specific task completion time model based on the completion time.

VI. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A method implemented by at least one computing device, comprising:
generating a user-specific task completion time model for a user;
identifying a new task to be performed by the user;
applying the user-specific task completion time model to the new task to generate an estimated time to complete the new task;
identifying a suitable period of user availability in which to perform at least a portion of the new task based at least on the estimated time to complete the new task; and
in response to identifying the suitable period of user availability, causing a notice about the new task to be presented to the user.

2. The method of claim 1, wherein generating the user-specific task completion time model for the user comprises:
collecting data from one or more electronic devices, the data being associated with the performance of one or more tasks by the user; and
utilizing the data to generate the user-specific task completion time model for the user.

3. The method of claim 2, wherein utilizing the data to generate the user-specific task completion time model for the user comprises generating a table that associates each of one or more task types with a corresponding completion time.

4. The method of claim 2, wherein utilizing the data to generate the user-specific task completion time model for the user comprises utilizing the data to train a machine learning algorithm that generates the task completion time model for the user.

5. The method of claim 1, wherein generating the user-specific task completion time model for the user comprises:
utilizing a non-user-specific task completion time model as an initial version of a task completion time model for the user; and
updating the non-user-specific task completion time model based on data collected from one or more electronic devices, the data being associated with the performance of one or more tasks by the user.

6. The method of claim 1, wherein applying the user-specific task completion time model to the new task to generate the estimated time to complete the new task comprises:
calculating the estimated time to complete the new task based on a completion time associated with each of one or more previously-completed tasks determined to be related to the new task.

7. The method of claim 1, further comprising:
determining an amount of time that it takes the user to complete the new task; and
updating the user-specific task completion model for the user based on the amount of time that it takes the user to complete the new task.

8. A system, comprising:
one or more processors; and
memory that stores computer program logic for execution by the one or more processors, the computer program logic including;
task identification logic configured to identify a task to be performed by a user;
task tracking logic configured to obtain an estimate of an amount of time required to complete the task; and
reminder generation logic that is configured to identify a period of user availability, to determine that the period of user availability is suitable for performing at least a portion of the task, the determining being based at least in part on the estimate of the amount of time required to complete the task, and in response to the determining, to cause a reminder about the task to be presented to the user.

9. The system of claim 8, wherein the task identification logic is configured to identify the task to be performed by the user based on one or more of: an analysis of one or more communications sent and/or received by the user, an analysis of one or more previously-detected activities of the user, and task information input by the user.

10. The system of claim 9, wherein the previously-detected activities comprise a partial completion of a task.

11. The system of claim 9, wherein the task identification logic is configured to identify the task to be performed by the user by identifying a habitual behavior of the user based on the analysis of the one or more previously-detected activities of the user.

12. The system of claim 8, wherein the reminder generation logic is configured to identify the period of user availability based on one or more of: calendar or appointment data obtained from an application or service utilized by the user, data that identifies a current location of the user, data concerning usage of a device, application or service by the user, and sensor data obtained by a device associated with the user.

13. The system of claim 8, wherein the task tracking logic is configured to obtain the estimate of the amount of time required to complete the task by applying a task completion time model to the task, the task completion time model being generated based at least in part on data that indicates how long it took the user to perform a same or similar task.

14. The system of claim 8, wherein the task tracking logic is configured to obtain the estimate of the amount of time required to complete the task by applying a task completion time model to the task, the task completion time model being generated based at least in part on data that indicates how long it took at least one other user to perform a same or similar task.

15. The system of claim 8, wherein the reminder generation logic is configured to determine that the period of user availability is suitable for performing the at least a portion of the task by determining that the period of user availability equals or exceeds the estimate of the amount of time required to perform the task.

16. The system of claim 8, wherein the reminder generation logic is further configured to identify one or more additional periods of user availability, and wherein the reminder generation logic is configured to determine that the period of user availability is suitable for performing the at least a portion of the task by determining that the period of user availability in combination with the one or more additional periods of user availability equals or exceeds the estimate of the amount of time required to perform the task.

17. The system of claim 8, wherein the reminder generation logic is further configured to determine that the period of user availability is suitable for performing the at least a portion of the task by determining one or more of: a mental and/or emotional state of the user, one or more resources currently available or unavailable to the user, user habits, user preferences, and imminence of a deadline associated with the task.

18. The system of claim 8, wherein the reminder generation logic is configured to cause the reminder about the task to be presented to the user by causing the reminder about the task to be presented to the user by a digital personal assistant executing on a device.

19. A computer program product comprising a computer-readable medium having computer program logic recorded thereon that, when executed by one or more processors, causes the one or more processors to perform a method for generating task reminders for a user, the computer program logic comprising:
first computer program logic that, when executed by the one or more processors, identifies a task to be performed by a user;
second computer program logic that, when executed by the one or more processors, applies a user-specific task completion time model to the task to obtain an estimate of an amount of time required to complete the task;
third computer program logic that, when executed by the one or more processors, identifies a period of user availability; and
fourth computer program logic that, when executed by the one or more processors, determines that the period of user availability is suitable for performing at least a portion of the task, the determining being based at least in part on the estimate of the amount of time required to complete the task, and in response to the determining, causes a reminder about the task to be presented to the user.

20. The computer program product of claim 19, wherein the computer program logic further comprises:
fifth computer program logic that, when executed by the one or more processors, determines a completion time for the task after the user has performed the task and updates the user-specific task completion time model based on the completion time.
